(19) United States
(12) Patent Application Publication
(10) Pub. No.: US 2022/0129108 A1
(43) Pub. Date: Apr. 28, 2022

(54) CAPTURING AUDIO AND VISUAL INFORMATION ON TRANSPARENT DISPLAY SCREENS

(71) Applicant: Pathway Innovations and Technologies, Inc., San Diego, CA (US)

(72) Inventors: Ji SHEN, San Diego, CA (US); Feng Gang WU, San Diego, CA (US)

(21) Appl. No.: 17/079,345

(22) Filed: Oct. 23, 2020

(51) Int. Cl. G06F 3/042

(52) U.S. Cl. CPC G06F 3/0425; G06F 3/04883; G06F 3/0428

(57) ABSTRACT

The present invention provides a display screen with an integrated video camera optimized to capture the display screen's information. A presenter writes or draws information on the display screen while facing an audience. The video camera is located on the side opposite from the presenter. No extraneous video production equipment or technical expertise is required to operate while providing a compact and easily transportable system.

### BACKGROUND OF THE INVENTION

### 1. Field of Invention

The invention relates to capturing information on display screens.

### 2. Description of Related Art

Handwriting remains an indispensable tool for teaching and instruction, for example, for students in a classroom, professionals in a business meeting, scholars at a conference, or anyone who wants to convey information to an audience. Traditionally, when an instructor, teacher, or presenter writes on a surface, it is often a whiteboard with a dry-erase marker, a blackboard with chalk, an interactive digital panel display with a stylus or hand/finger gestures. The whiteboard, blackboard, or other surface is typically mounted or stationed along a room wall. For example, teachers will often lecture at the head of a room with a whiteboard mounted behind them. A significant drawback to this orientation is that it requires the teacher or presenter to turn their back to the audience to write on the display screen.

U.S. Pat. Nos. 10,523,893 and D809,600 to Anderson et al., the entire disclosures of which are incorporated by reference herein, provide a “lightboard” for presenting visual information. The lightboard comprises a transparent display screen. Light is injected at an edge of the screen and illuminates writing or drawings on the display screen. Such a system permits a presenter, located on one side of the display screen, to face an audience situated on the opposite side of the display screen. Information on the display screen and audio, e.g., the presenter's speech, can be captured by a video camera on the audience side. A processor, either in the video camera or a computer or display device coupled to the video camera, flips the video so that writing and drawings are displayed to the audience correctly. That video can be displayed on a separate monitor. A drawback of such a system is the need for a standalone video capturing system, including a camera, lighting, mirrors, and specific filters. Not only is the extraneous equipment expensive, but it is bulky, fragile, and difficult to transport, as well as requiring technical expertise to set up and operate.

In light of these challenges in the field, there exists a need for a display screen on which a user can present information that has an integrated camera and allows the presenter to face the audience while writing on the writing surface, and that is also compact, easy to transport, and easy to use. This need has heretofore remained unsatisfied.

### SUMMARY OF THE INVENTION

The present invention overcomes these and other deficiencies of the prior art by providing a display screen integrated with a video camera optimized to capture information on the display screen. A presenter writes or draws information on the display screen while facing an audience. The present invention does not require extraneous video production equipment or technical expertise to operate while providing a compact and easily transportable system.

In an embodiment of the invention, a device comprises: a display screen; a frame traversing at least a portion of a perimeter of the display screen; an extension comprising a distal end and a proximal end, wherein the proximal end of the extension is connected to the frame; and a video camera coupled to the extension. The frame comprises a light source injecting light into an edge of the display screen. The device may further comprise a stand coupled to the frame. The display screen comprises a first surface and a second surface opposite the first surface, and wherein the extension extends from the second surface. The video camera is coupled to the extension at the distal end and oriented in a direction toward the second surface. The display screen is transparent and comprises a material selected from the group consisting of: glass, acrylic, plexiglass, polycarbonate, cellophane, latex, polyurethane, melamine, vinyl, polyester, and any combination thereof. The video camera comprises a filter having a frequency band including the frequency of the injected light.

In another embodiment of the invention, a method for capturing visual information comprises the steps of: capturing, with a video camera coupled to an extension coupled to a display screen, information presented on the display screen; processing the captured information into processed information; and transmitting the processed information to a display. Processing the captured information comprises reorienting captured multimedia information about a vertical axis or superimposing a predetermined image or video. The method may further comprise injecting, from a light source connected to the frame, light into an edge of the display screen. The injected light is blue light and processing the captured information comprises filtering the captured information with a blue filter. The display screen is transparent and comprises a material selected from the group consisting of: glass, acrylic, plexiglass, polycarbonate, cellophane, latex, polyurethane, melamine, vinyl, polyester, and any combination thereof.

In yet another embodiment of the invention, an apparatus comprises: a display screen; a frame traversing at least a portion of a perimeter of the display screen; an extension connected to the frame; a video camera coupled to the extension; at least one processor; and at least one memory including computer program code for one or more programs, the at least one memory and the computer program code configured to, with the at least one processor, cause the apparatus to perform at least the following, capturing, with the video camera, information presented on the display screen; processing the captured information; and transmitting the processed information to a display. The apparatus may further comprise a light source injecting light into an edge of the display screen. The injected light is blue light. The extension is connected to the frame at a proximal end of the extension, and wherein the video camera is coupled to a distal end of the extension, the distal end is located opposite the proximal end. The display screen comprises a first surface and a second surface opposite the first surface, the extension extends from the second surface, and the video camera is oriented in a direction toward the second surface. The display screen is transparent and comprises a material selected from the group consisting of: glass, acrylic, plexiglass, polycarbonate, cellophane, latex, polyurethane, melamine, vinyl, polyester, and any combination thereof.

The present invention has many advantages over the prior art. For example, the present invention provides a “turn-key” solution to many problems experienced in the relevant art, i.e., easily implemented and requires little to no setup and adjustment before use. Various components of the present invention are pre-optimized to work together. The video camera is pre-configured to work seamlessly with the display screen by, for example, having an optimal focal length for use with the display screen, having filters pre-loaded or pre-installed, and by providing a fixed distance and angle from the display screen. Additionally, the display screen includes built-in lights that project a specific spectrum of light for the display screen's optimal illumination. These lights are also easily controlled by a built-in control panel while being pre-optimized to maximize visibility and legibility to a viewer. Such features remove all of the guesswork in setting up and provide a compact, lightweight, and easy transport package.

The foregoing and other features and advantages of the invention will be apparent from the following, more particular description of the invention's preferred embodiments and the accompanying drawings.

### BRIEF DESCRIPTION OF THE DRAWINGS

For a complete understanding of the present invention, the objects and advantages thereof, reference is now made to the ensuing descriptions taken in connection with the accompanying drawings briefly described as follows:

FIGS. 1 and 1A illustrate an exemplary device for capturing board writing, according to an embodiment of the invention;

FIG. 2 illustrates an exemplary device for capturing board writing with markings shown, according to an embodiment of the invention;

FIG. 3 illustrates an exemplary device for capturing board writing with displays, according to an embodiment of the invention; and

FIG. 4 illustrates an exemplary system for capturing board writing, according to an embodiment of the invention;

FIG. 5 illustrates exemplary perspective views of a device for capturing board writing with the video camera in an upright orientation, according to an embodiment of the invention;

FIG. 6 illustrates exemplary perspective views of a device for capturing board writing with the video camera in a stowed orientation, according to an embodiment of the invention;

FIG. 7 illustrates an exemplary device for capturing board writing with a removably coupled extension, according to an embodiment of the invention;

FIGS. 8A and 8B illustrate an exemplary device for capturing board writing with supports, according to an embodiment of the invention;

FIG. 9 illustrates an exemplary device for capturing board writing with an interactive display, according to an embodiment of the invention; and

FIGS. 10A and 10B illustrate an exemplary device for capturing board writing with a video camera located in a lower position, according to an embodiment of the invention.

Throughout the drawings, identical reference characters and descriptions indicate similar, but not necessarily identical, elements.

### DETAILED DESCRIPTION OF PREFERRED EMBODIMENTS

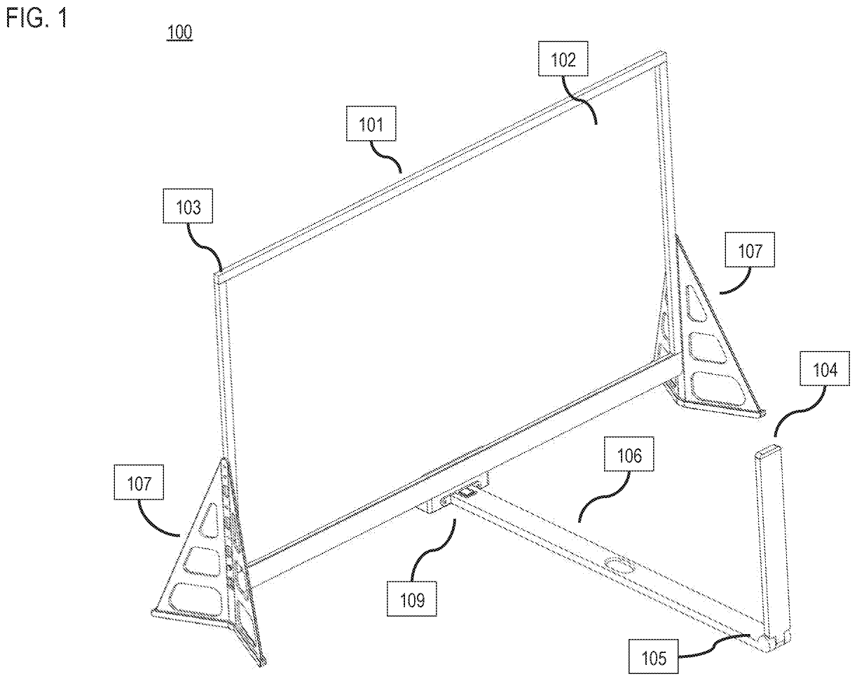

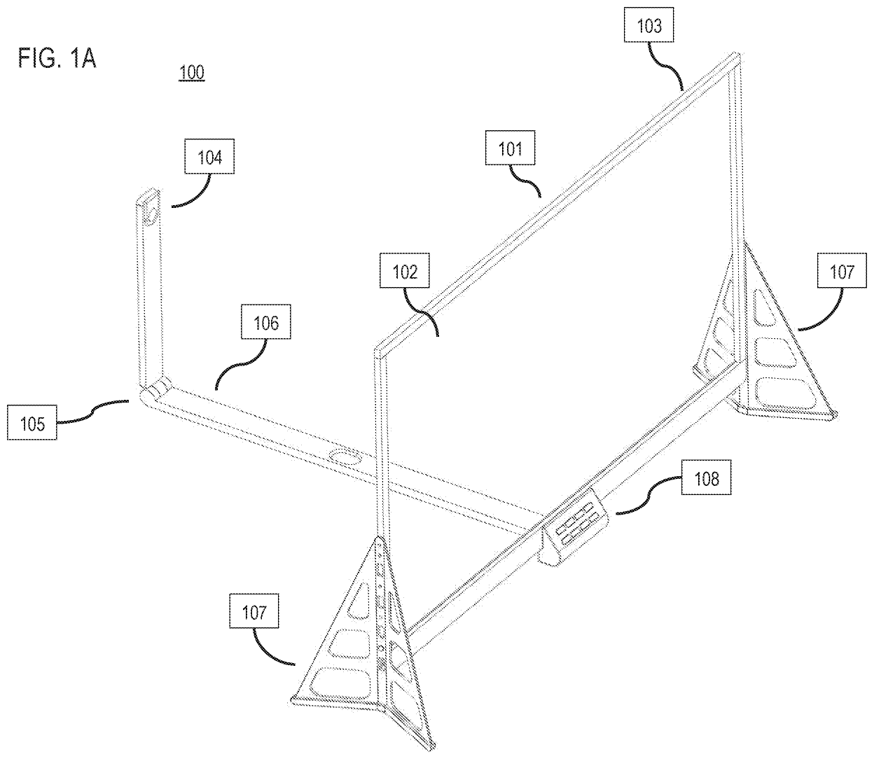

Preferred embodiments of the present invention and their advantages may be understood by referring to FIGS. 1-10B. The described features, structures, or characteristics of the invention may be combined in any suitable manner in one or more embodiments. It will be apparent to those skilled in the art that various modifications and variations can be made to the present invention without departing from the invention's spirit and scope. Thus, it is intended that the current invention cover modifications and variations consistent with the scope of the appended claims and their equivalents.

The present invention provides a solution for capturing audio and visual information presented on transparent, semi-transparent, or translucent display screens while permitting the presenter to face an audience or video camera. For simplicity, a display screen or writing surface with transparent, semi-transparent, or translucent properties is referred to herein as a transparent display screen or a transparent writing surface. In an embodiment of the invention, a presentation device comprises a transparent display screen with an integrated video camera optimized for the display screen. A presenter conveys information on one side of the display screen, as if writing on a whiteboard. The video camera captures (or audience observes) the information from the opposite side of the display screen. The display screen comprises a light source to inject light into an edge of the display screen to illuminate the display screen's information.

FIGS. 1 and 1A illustrate a presentation device 100 according to an embodiment of the invention. The presentation device 100 comprises a display screen 101 with a transparent writing surface 102 and a frame 103 surrounding some or all of the writing surface 102. In other embodiments, the frame 103 may traverse less than all of the writing surface's perimeter.

The display screen 101 can be any rigid, semi-rigid, or flexible material that is substantially, if not wholly, transparent. Substantially transparent refers to a degree of transparency sufficient to convey information presented (and optionally the presenter) on one side of the writing surface 102 to the opposite side of the writing surface 102. As noted above, the term transparent as used herein includes semi-transparent and translucent properties for ease of reference.

For example, the writing surface 102 may comprise glass. Preferably, the glass is tempered to provide strength and add safety if the glass display screen breaks or shatters. However, the writing surface 102 may comprise any suitable transparent, semi-transparent, or translucent material. For example, the writing surface 102 may include acrylic, plexiglass, polycarbonate, cellophane, latex, polyurethane, melamine, vinyl, polyester, or any combination thereof. In some embodiments, the writing surface 102 may be a single layer, or in other embodiments, the writing surface 102 may be multi-layered. In such a multi-layered embodiment, the writing surface 102 may have multiple layers of the same material, i.e., multiple layers of glass. Alternatively, the writing surface 102 may comprise multiple layers of different materials. For example, the writing surface 102 may include one or more glass layers and one or more layers of a polymer or polymeric material. Additionally, in such multi-layered embodiments, the various layers may be spaced apart or have an air gap between one or more layers.

Although the display screen 101 is shown as generally rectangular and flat, it may take any shape and orientation. For example, in some embodiments, the display screen 101 is rectangular. In other embodiments, the display screen 101 is circular or ovular in shape. In other embodiments, the display screen 101 can be curved to focus light directly on the audience or video camera 104.

The frame 103 comprises any suitable material, for example, any rigid or semi-rigid material including, but not limited to, wood, plastic, metal, or any combination thereof. The frame 103 comprises a light source such as light-emitting diodes (“LEDs”) to inject light into the writing surface 102 in a predetermined manner. In some embodiments, the light emitted from the illuminating devices may be in the visible spectrum or outside the visible spectrum. For example, the light emitted from the light sources is blue light, i.e., light with a wavelength of approximately 380 nm to 500 nm. In another example, the light emitted from the light source within the frame may be ultraviolet (e.g., blacklight), with a wavelength of approximately 350 nm to 400 nm.

In an embodiment of the invention, the ink used with the writing surface 102 is tailored to maximize visibility with the injected light. For example, in an embodiment where blue light is injected from the light source, fluorescent ink that is especially visible in blue light can be utilized to maximize the visibility to the audience or viewing devices. Additionally, a built-in light source has the advantage of having its incidence angle (i.e., the angle at which the light interacts with the display screen) predetermined to maximize visibility to a viewer while minimizing its intrusion to the presenter. In such embodiments where particularized wavelengths of light are injected, the video camera 104 or accompanying software or firmware may have filters pre-installed or preloaded that would filter out unwanted colors/effects from the captured multimedia information. In other words, one or more filters correspond to the frequency of light injected. For example, the video camera 104 employs a blue filter when blue light is injected, as noted above. The video camera may implement polarization filters as well. For example, in the case of a confidence monitor being present, the implementation of which is apparent to one of ordinary skill in the art, a polarization filter eliminates reflections on the writing surface 102 from the confident monitor.

The presentation device 100 comprises an integrated video camera 104. The video camera 104 can be, for example, a document camera, a single-lens reflex (“SLR”) camera, a digital SLR (“DSLR”) camera, a mirrorless camera, a digital camcorder, or a sports or action camera. The integrated video camera 104 may be detachably coupled as a modular camera to the presentation device 104.

Providing an integrated video camera 104 has several advantages over the prior art. For example, the field of view (“FOV”), i.e., the amount of visible area, can be tailored to specific applications. In such an example, the FOV can be such that only the writing surface 102 is observable, and the frame 103 (or other extraneous objects) is not. Tailoring the FOV can be accomplished in the video camera's 104 hardware by, for example, having an optical sensor with a predetermined size to match that of the writing surface 102, or in post-production, for example, by digitally cropping the captured multimedia information to excise unwanted portions. Another parameter that can be optimized is the exposure, i.e., the amount of light per unit area reaching the surface of an electronic image sensor, and is adjusted by shutter speed, lens aperture, or scene luminance. Another parameter that can be optimized is the depth of field, i.e., the distance between the closest and farthest objects in a photo or video stream that appears acceptably sharp. This parameter is important because if the video camera's 104 depth of field is too shallow, the writing surface 102 or the presenter, but not both, with be in focus, detracting from the acceptability of the visual experience provided by the present invention.

In an exemplary embodiment of the invention, the video camera 104 is detachably coupled to the distal end of an extension 106 attached to the frame 103 at a proximal end 109. Additionally, the extension 106 may have hinge 105 or another orientating mechanism that allows the video camera 104 to be folded to facilitate easy storage or transportation. The hinge 105 or another orientating mechanism can also correctly position or orientate the video camera 104. While in use, the video camera 104 is orientated in a direction towards the display screen 101. In this way, the video camera 104 captures the information on the writing surface 102 in the form of multimedia information, i.e., video. Because the information on the writing surface 102 is marked on the side opposite the video camera 104, the writing will be reversed when viewed from the audience's and video cameras' 104 perspectives. Accordingly, the multimedia information captured by the video camera 104 is processed to reverse (or “flip”) the image/multimedia information about a vertical axis, thereby reorientating the image/video in a manner that appears “correct” to an audience member. Although multimedia information may be discussed herein in the context of a video stream (with or without audio), multimedia information also includes photos, still images, video stills/frames, video images, and video streams, either compressed or uncompressed, without departing from the contemplated embodiments.

The presentation device 100 may optionally utilize one or more displays for displaying the video captured by the video camera 104. Such a display can be any type of display, the identification and implementation of which are apparent to one of ordinary skill in the art. Exemplary displays include electroluminescent (“ELD”) displays, liquid crystal display (“LCD”), light-emitting diode (“LED”) backlit LCD, thin-film transistor (“TFT”) LCD, light-emitting diode (“LED”) displays, OLED displays, AMOLED displays, plasma (“PDP”) display, and quantum dot (“QLED”) displays. Additionally, the displays can be standalone units such as televisions or computer monitors or integrated into other devices such as cellular telephones and tablet computers. The one or more displays may further comprise touch-sensitive displays capable of interacting with a user's finger or an electronic/digital pen.

In an embodiment of the invention, the video camera 104 or other hardware and software components described herein can be used to facilitate built-in video conferencing. In such an embodiment, a user can initiate a video teleconference wherein the video camera 104 captures multimedia information communicated to other video teleconference members.

As shown in FIG. 1, the extension 106 may be detachably coupled to the frame 103 at connector 109. The video camera 104 is mounted at the distal end of the extension 106. In some embodiments, the extension 106 may comprise a hinge or other orientating mechanism 105 to facilitate the video camera's 104 orientation toward the writing surface 102.

The presentation device 100 is preferably configured to be free-standing, e.g., set on a table or other horizontal surface. In such an embodiment, the presentation device 100 comprises stands 107 that allow the display screen 101 to sit in an upright orientation. The stands 107 may include mounts that attach the stands 107 to the frame 103 and may be adjustable so that the display screen's 101 height may be raised or lowered relative to the horizontal surface on which it stands.

The presentation device 100 further comprises a control panel 108 used to control various aspects of the presentation device 100. For example, the control panel 108 may be configured to control the video camera 104 (or various attributes thereof, e.g., exposure, contrast, saturation, DOF, FOV, etc.). The control panel may also control light sources integrated into various parts of the presentation device 100, e.g., the frame 103. In some embodiments, the control panel 108 is embodied by a separate tablet, cellphone, or another smart device. In such an embodiment, the control panel 108 may further comprise an interactive display, which may be configured to view or control the multimedia information captured by the video camera 104, participate in video conferencing, and the like.

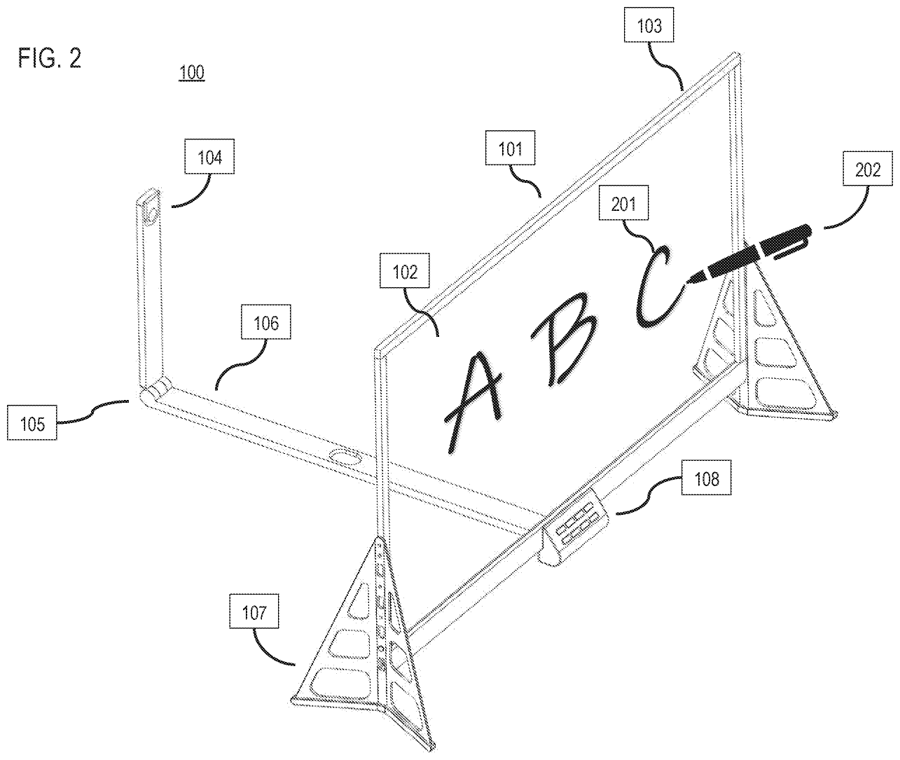

With reference to FIG. 2, a presenter or other user utilizes a pen or marker 202 to mark a writing 201 on the display screen 101. For example, the user (not shown) draws “A B C” 201 on the display screen 101. The video camera 104 captures video that includes the writing 201. Notably, the writing 201 is marked on the writing surface 102 on the side opposite to that of the video camera 104, and thus, when viewed from the video camera's 104 perspective, the writing 201 appears backward.

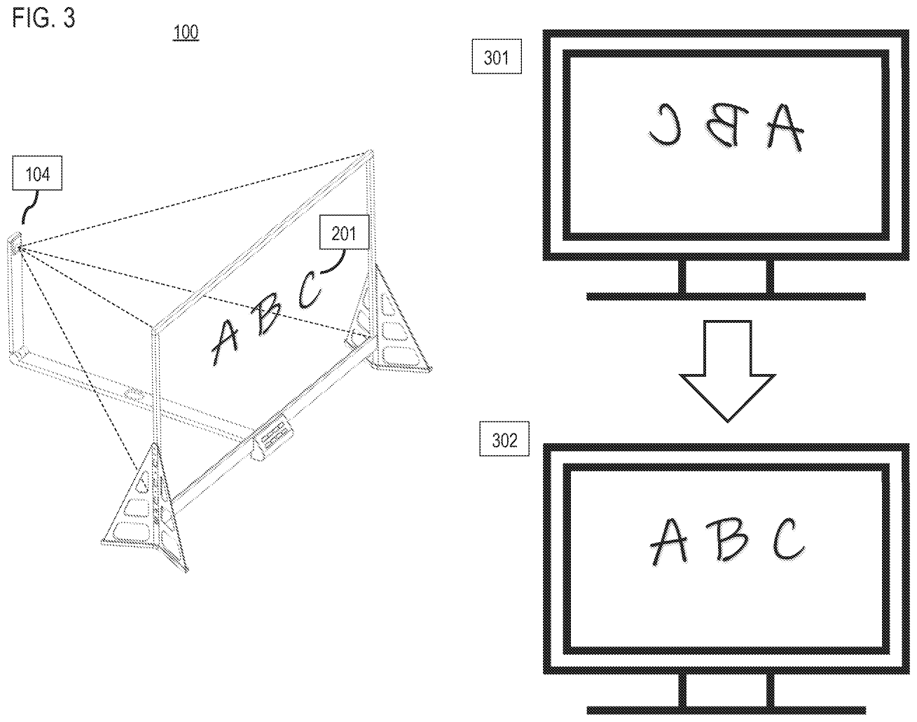

Continuing with the previous exemplary embodiment and with reference to FIG. 3, the video camera 104 captures the writing 201 from a perspective opposite to that of the writer/presenter (not shown). If the video captured by the video camera 104 were viewed without processing, the images would appear reversed. For example, if displayed without reorientation, the writing 201 would appear as shown on display 301. However, the presentation device 100 (or a separate computer or display coupled to it) processes the multimedia information captured by the video camera 104 to reorientate, i.e., flip, it about a vertical axis. Once processed, the writing 201 appears correctly orientated and in the writer's direction, as shown on display 302. In this way, the device 100 captures multimedia information (e.g., audio and video) from a perspective opposite the writer/presenter. Still, it produces the video rearranged in the correct orientation in real-time or near-real-time, i.e., with an imperceptible delay to an ordinary human observer. In addition to reorientating the multimedia information, the device 100 can also process the multimedia information to effectuate other desired outcomes, such as adjusting the exposure, brightness, focus, saturation, sounds, DOF, FOV, or other audio-visual effects. The device 100 can also process the multimedia information by compressing the video or sound stream to decrease latency, decrease the storage space required, or facilitate transmissibility, the implementation of which is readily apparent to one of ordinary skill in the art.

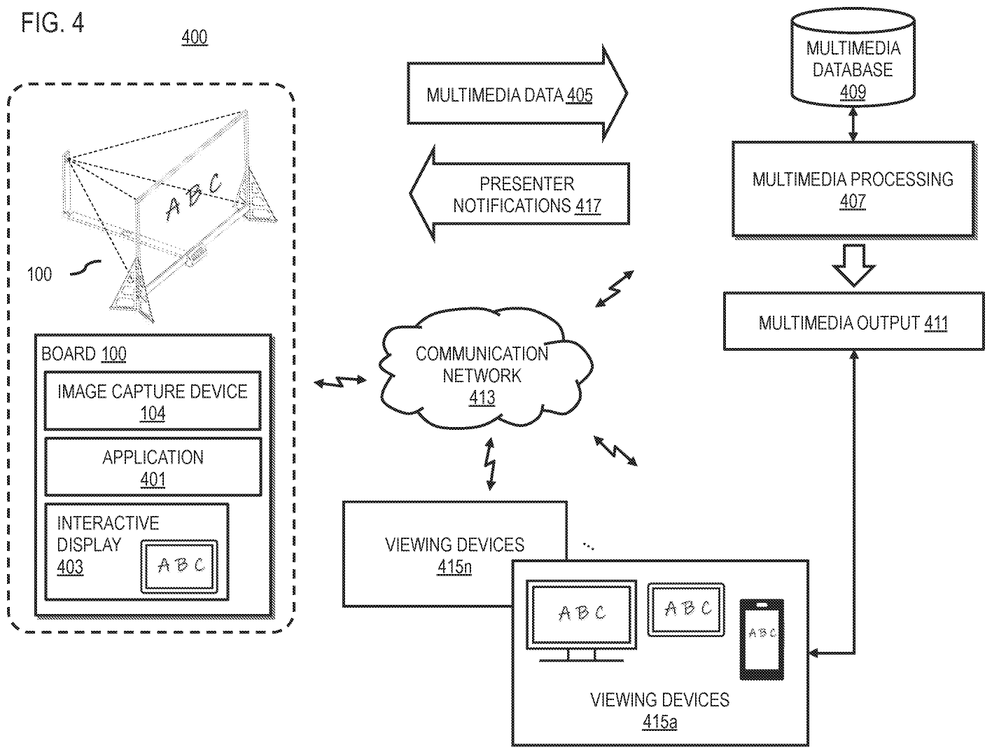

In another exemplary embodiment and with reference to FIG. 4, a system 400 captures writings 201 and transmits the information to viewing devices 415(a)-(n). The presentation device 100 comprises an integrated video camera 104 and an application 401 loaded thereon and configured to control various aspects of the system or effectuate processes described herein. The presentation device 100 may further comprise a controller/interactive display 403. Once the video camera 104 captures multimedia information, including the writing 201, e.g., a video, the multimedia information is transmitted for multimedia processing at step 407. The multimedia information can be transmitted across the communication network 413. As part of the processing, the system 400 reorientates a visual component about a vertical axis, as noted above. The system 400 stores the multimedia information in multimedia database 409, either before or after processing. Once processed, the multimedia information is outputted, at step 411, to various devices. For example, the processed multimedia information can be sent to viewing devices 415a-n. Such viewing devices 415a-n may include televisions, monitors, computers, desktop computers, laptop computers, kiosks, smartphones, portable electronic devices, tablets, or any other device comprising a display screen. One or more of the viewing devices 415a may communicate with other viewing devices 415n through the communication network 413 or directly, for example, via Bluetooth. In an embodiment utilizing built-in video conferencing, the viewing devices 415a-n may be participants in the teleconference along with the user/presenter using the presentation device 100. The communication network 413 may be the Internet or any computer network, the identification and implementation of which are apparent to one of ordinary skill in the art.

One or more of the viewing devices 415a can send information back to the system 400. In such an example, a user of the viewing device 415a can send, for example, a presenter notification 417 to the display screen 101 or other components thereof. The notification 417 can be displayed, for instance, on interactive display 403. In the context of a classroom setting, a student using viewing device 415a can, for example, send a question 417 to the instructor using display screen 101. The question 417 may then be displayed on display 403. The instructor may use interactive display 403 or application 401 to answer or cancel the question 417. The question 417 can also be displayed on one or more of the viewing devices 415n. Other students using the viewing devices 415n may also be able to answer/cancel the question 417 with or without input from the instructor using display screen 101.

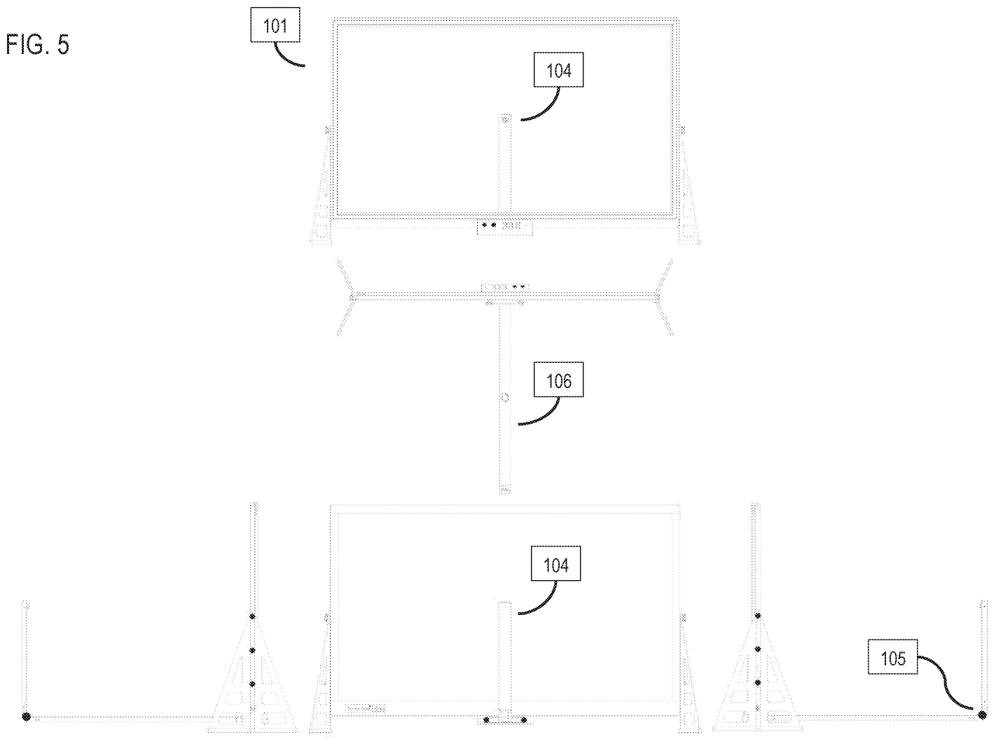

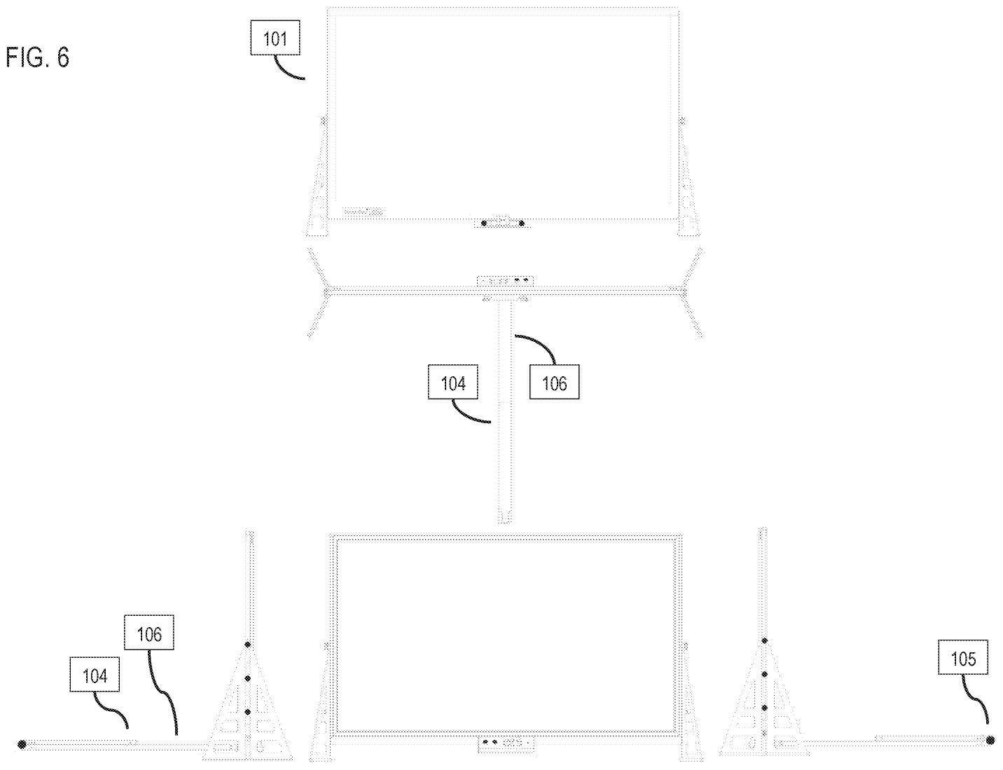

FIGS. 5 and 6 illustrate various perspective views of certain embodiments of the present invention. FIG. 5 illustrates the video camera 104 extended in an upright orientation. Contrastingly, FIG. 6 illustrates the video camera 104 collapsed using hinge 105. The display screen 101, video camera 104, and extension 106 can be easily collapsed to facilitate easy transport.

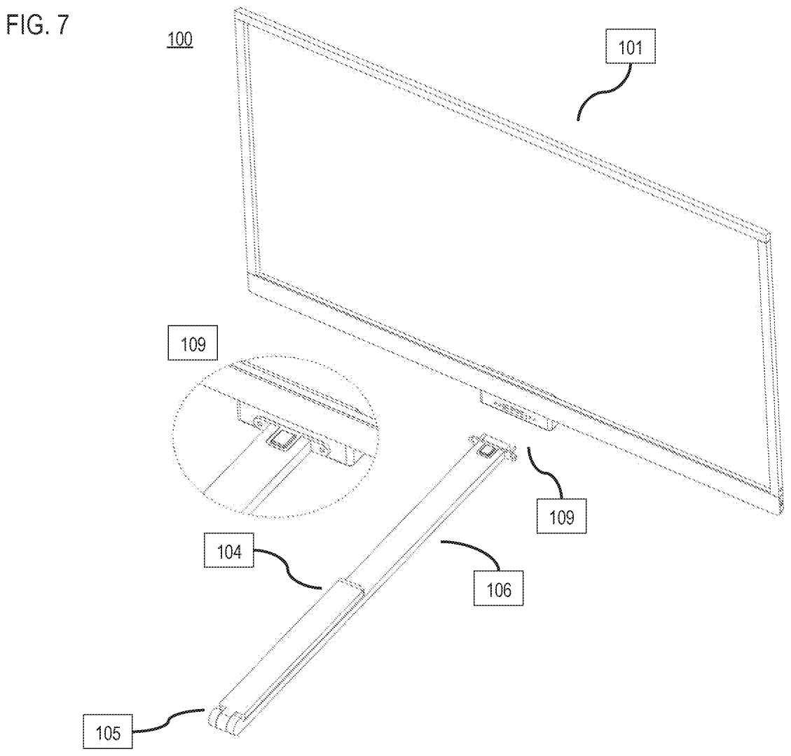

In another exemplary embodiment and with reference to FIG. 7, the video camera 105 can be collapsed at hinge 105 (e.g., folded) to facilitate easy storage or transportation. The extension 106 may also be removably attached to the frame 103 at connection 109 using screws or a one-button quick disconnect. In another embodiment, connector 109 may also comprise a hinge or other orientating mechanism (not shown) to allow the extension 106 to collapse without being detached from display screen 101. FIG. 7 also illustrates an embodiment of the present invention that is not free-standing.

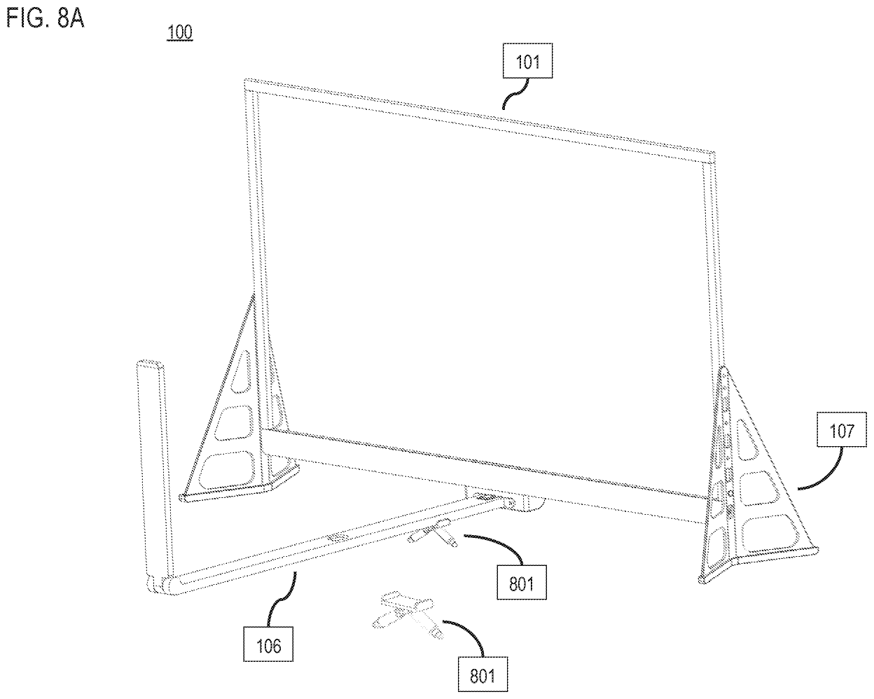

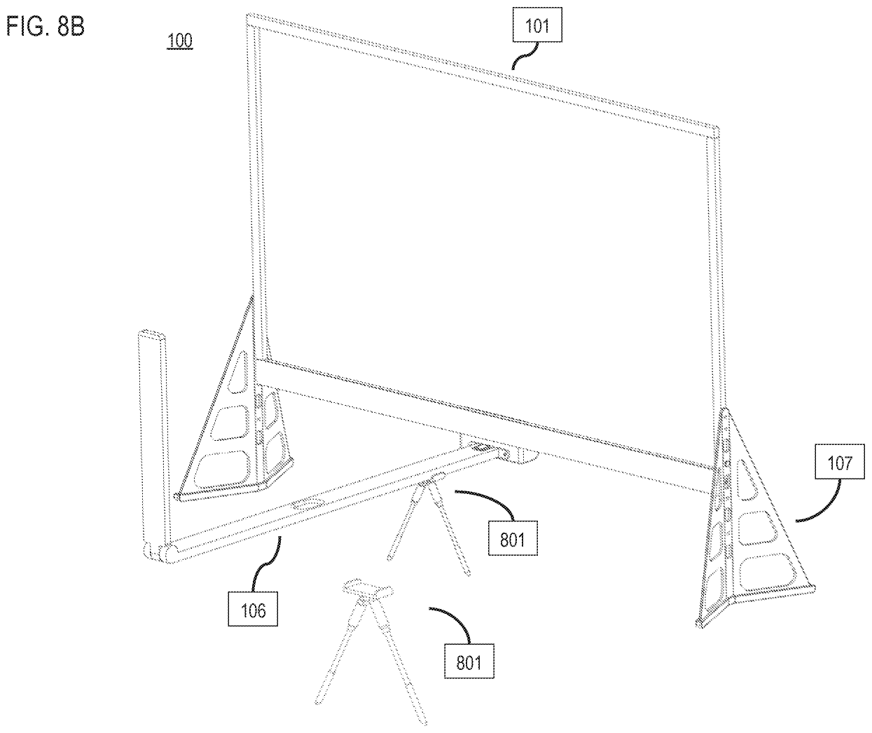

In another exemplary embodiment and with reference to FIGS. 8A and 8B, the presentation device 100 may further comprise a support 801 to support the extension 106 and alleviate some of the stress at connector 109. Support 801 may be configured so that it can be mounted to the extension 106 at any point. Additionally, the support 801 may have telescopic legs allowing the support 801 to vary in height. For example, in FIG. 8A, the display screen 101 is mounted to the stands 107 in a relatively low position. In this embodiment, the legs of the support 801 are also retracted to match the height of the display screen 101. In contrast, as shown in FIG. 8B, the display screen 101 is mounted to the stands 107 in a relatively high position. In this embodiment, the support's 801 legs are also extended to match the height of the display screen 101. In this way, the support 801 enables the user to ensure the video camera 104 is correctly orientated relative to the display screen 101.

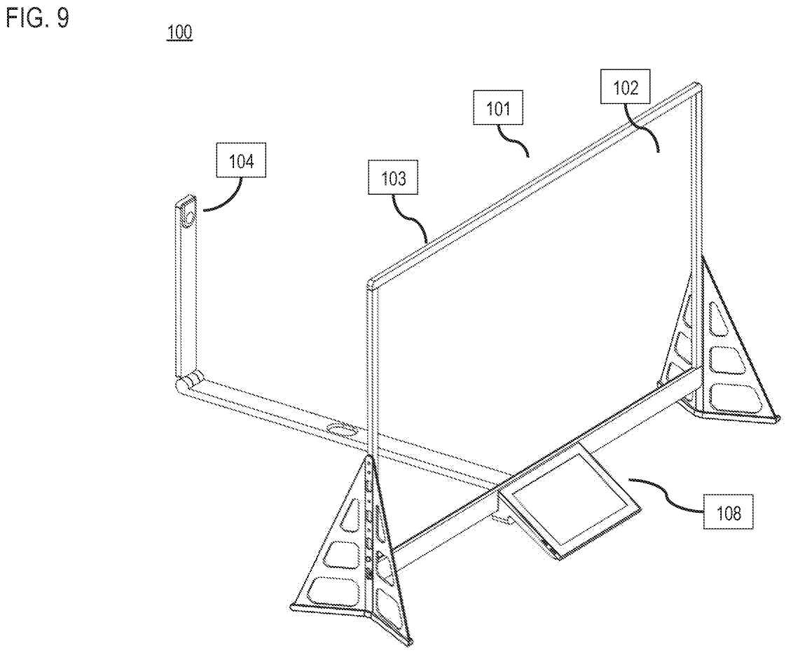

In another exemplary embodiment and with reference to FIG. 9, the presentation device 100 may comprise an interactive display 108. The display 108 may include a user interface that allows the user to control one or more aspects of the present invention. For example, the interactive display 108 can enable the user to view the video captured by the video camera 104 and adjust specific settings, for example, the exposure. The interactive display 108 may also allow a user to control light sources (not shown) integrated into the frame 103.

In an alternative embodiment of the invention, the display screen 101 comprises a transparent touch-sensitive interactive display, e.g., a transparent digital whiteboard. A user could write or draw in the touch-sensitive display 102 using his or her hand or a stylus, and those markings will be shown on the display 102 in real-time. In such an embodiment, the multimedia information captured by the video camera 104 can be processed independently of or in conjunction with the markings captured by the digital whiteboard 102. Additionally, in such an embodiment, the interactive display 108 can control one or more functions of the video camera 104.

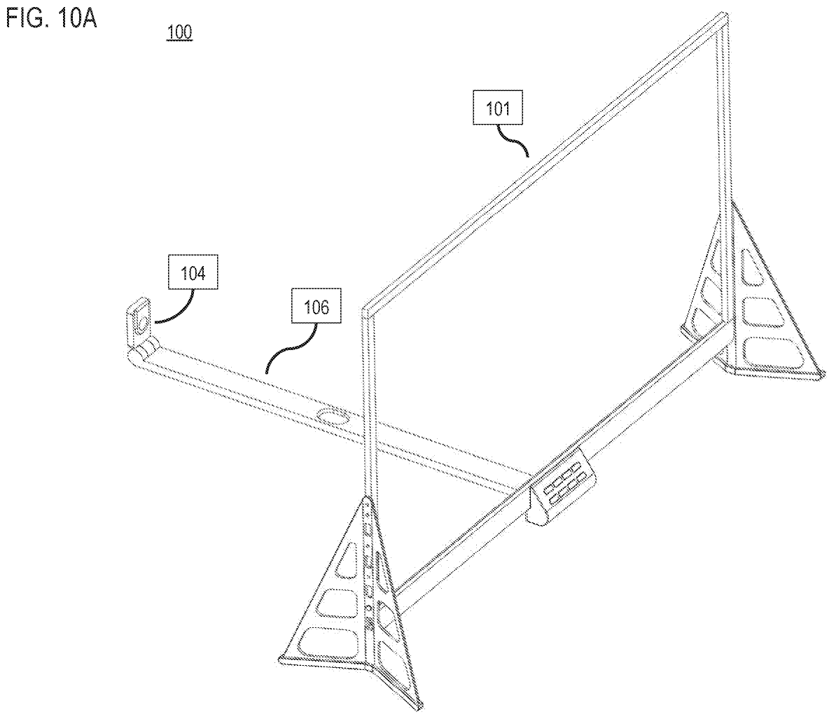

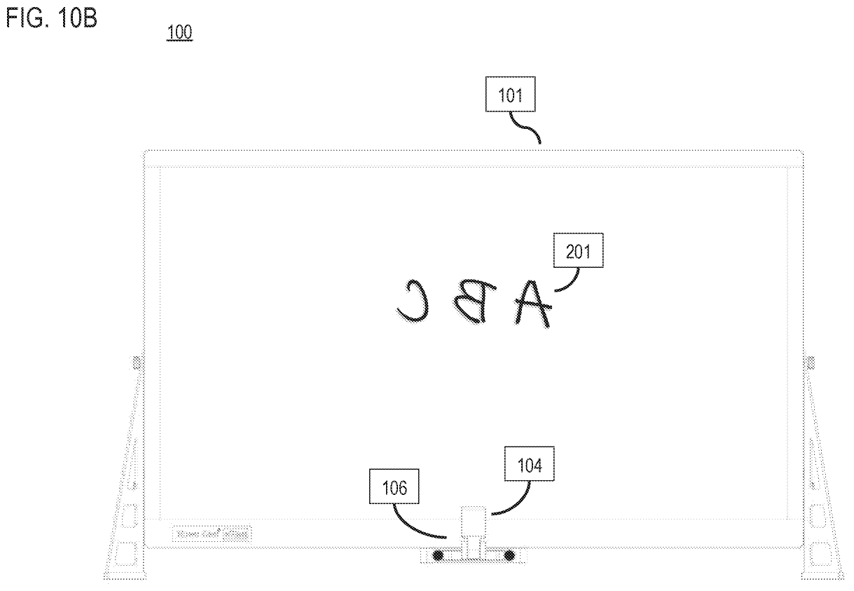

In another exemplary embodiment and with reference to FIGS. 10A and 10B, the image capture device 104 can be located lower relative to the display screen 101 than other embodiments, for example, as shown in FIGS. 1 and 1A. Here, an audience member (not shown) would have an easier time viewing the presenter (not shown). However, in such an embodiment, additional processing may be required to correct perceived deformations in writings 201 caused by the lower aspect angle of the video camera's 104 lower relative position.

The present invention also facilitates image insertion. In an embodiment of the invention, the video camera 104 or a computer coupled to it superimposes a computerized image or video onto the captured video. For example, a computerized image can be a double-stranded DNA molecule. The presenter sees the double-stranded DNA molecule on a separate confidence monitor, but not the writing surface 102. With the confidence monitor's aid, the presenter can write or draw information on the writing surface 102 as if the double-stranded DNA molecule was present, thereby creating a captured video having both the information and the double-stranded DNA molecule.

While the invention has been described in connection with a number of embodiments and implementations, the invention is not so limited but covers various apparent modifications and equivalent arrangements, which fall within the purview of the appended claims. Although features of the invention are expressed in certain combinations among the claims, it is contemplated that these features can be arranged in any combination and order. The invention has been described herein using specific embodiments for illustrative purposes only. It will be readily apparent to one of ordinary skill in the art, however, that the principles of the invention can be embodied in other ways. Therefore, the invention should not be regarded as limited in scope to the specific embodiments disclosed herein; it should be fully commensurate in scope with the following claims.

We claim:

1. A device comprising:
a display screen;
a frame traversing at least a portion of a perimeter of the display screen, wherein the frame comprises a light source injecting light into an edge of the display screen;
an extension comprising a distal end and a proximal end, wherein the proximal end of the extension is connected to the frame;
a video camera coupled to the extension;
a control panel affixed to the frame, wherein the control panel controls the light source and operation of the video camera.

2. (canceled)

3. The device of claim 1 further comprising a stand coupled to the frame.

4. The device of claim 1, wherein the display screen comprises a first surface and a second surface opposite the first surface, and wherein the extension extends from the second surface.

5. The device of claim 4, wherein the video camera is coupled to the extension at the distal end and oriented in a direction toward the second surface.

6. The device of claim 1, wherein the display screen is transparent and comprises a material selected from the group consisting of: glass, acrylic, plexiglass, polycarbonate, cellophane, latex, polyurethane, melamine, vinyl, polyester, and any combination thereof.

7. The device of claim 1, wherein the video camera comprises a filter having a frequency band including the frequency of the injected light.

8. A method for capturing visual information, the method comprising the steps of:
injecting, from a light source connected to a frame of a display screen, light into an edge of the display screen;
capturing, with a video camera coupled to an extension coupled to the display screen, video comprising information written on the display screen and a presenter creating the information written;
processing, via software, the captured video into processed video, wherein the step of processing comprises applying a light filter; and
transmitting the processed video to a remote display.

9. The method of claim 8, wherein processing the captured video comprises reorienting captured multimedia information about a vertical axis.

10. The method of claim 8, wherein processing the captured video comprises superimposing a predetermined image or video.

11.-13. (canceled)

14. The method of claim 8, wherein the display screen is transparent and comprises a material selected from the group consisting of: glass, acrylic, plexiglass, polycarbonate, cellophane, latex, polyurethane, melamine, vinyl, polyester, and any combination thereof.

15. An apparatus comprising:
a display screen;
a frame traversing at least a portion of a perimeter of the display screen, wherein the frame comprises a light source injecting light into an edge of the display screen;
an extension connected to the frame;
a video camera coupled to the extension;
a control panel affixed to the frame, wherein the control panel controls the light source and operation of the video camera
wherein the extension is connected to the frame at a proximal end of the extension, and wherein the video camera is coupled to a distal end of the extension, the distal end is located opposite the proximal end;
at least one processor; and
at least one memory including computer program code for one or more programs, the at least one memory and the computer program code configured to, with the at least one processor, cause the apparatus to perform at least the following,
capturing, with the video camera, video comprising information written on the display screen and a presenter creating the information written;
processing, via software, the captured video, wherein the step of processing comprises applying a light filter; and
transmitting the processed video to a remote display.

16.-18. (canceled)

19. The apparatus of claim 15, wherein the display screen comprises a first surface and a second surface opposite the first surface, the extension extends from the second surface, and the video camera is oriented in a direction toward the second surface.

20. The apparatus of claim 15, wherein the display screen is transparent and comprises a material selected from the group consisting of: glass, acrylic, plexiglass, polycarbonate, cellophane, latex, polyurethane, melamine, vinyl, polyester, and any combination thereof.
